(19) United States
(12) Patent Application Publication
(10) Pub. No.: US 2014/0029105 A1
(43) Pub. Date: Jan. 30, 2014

(54) Solar igloo

(71) Applicant: John Edward Fay, Wilmette, IL (US)

(72) Inventor: John Edward Fay, Wilmette, IL (US)

(21) Appl. No.: 13/507,747

(22) Filed: Jul. 25, 2012

(51) Int. Cl. G02B 27/12

(52) U.S. Cl. 359/622

(57) ABSTRACT

Using creativity and prior art, this invention creates machinery to collect sunlight for a variety of useful purposes, which (in addition to electricity-generation) include military, law enforcement, industrial, agricultural, lighting, climate control, utility, and “appliances” applications.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This invention pertains not only to the field of solar energy, but also has important military, law enforcement, industrial, agricultural, lighting, climate control, utility, and “appliance” applications. Specifically, the invention is a machine that can collect solar energy, for a wide variety of uses.

A general knowledge of how a magnifying glass can bend sunlight, and a general knowledge of how heat (and/or electricity) can be generated from collecting and concentrating sunlight, is all that's necessary, for a person of ordinary skill in the art, to understand the invention.

The only real “problem” the invention solves is the current technology's failure to creatively, simply, and effectively apply the prior art to the problem of collecting sunlight.

### BRIEF SUMMARY OF THE INVENTION

As many school-children have learned in science class, holding a magnifying glass between a piece of paper and the sun, so the magnifying glass is pointed toward the sun, and so a tiny image of the sun appears through it, on the paper, can set the paper on fire, because the magnifying glass, in that situation, bends all the sun's rays it touches onto that one, tiny spot on the paper.

Furthermore, as many school-children also know (from reading the often-assigned book, entitled, “Fahrenheit 451”) book-paper is said to burn at about 451 degrees Fahrenheit.

Thus, it is truly amazing to consider that something as small, simple, and inexpensive as a hand-held magnifying glass, could generate a light beam of about 451 degrees Fahrenheit, and do so in such a short period of time. And, that simple fact is the principle upon which The Solar Igloo operates.

Today, mankind's appetite for clean, renewable energy is soaring (along with our need to attain energy independence, and stop sending billions of our dollars, each year, to enemies of this country, just because we—with the immense natural resources of United States—haven't yet had the wits to harness the rest of our own energy).

Sunlight is an absolutely enormous source of energy, and we have vast access to it throughout our entire country. Some creative soul needs to pick up, again, where others have left off, and finally find a simple and effective way of harnessing this vast resource for electricity-generation, and other applications, and that's what this invention is all about. There have been numerous attempts to accomplish this, over the years, but none, so far, has truly proven satisfactory.

This invention doesn't involve any new scientific discoveries, per se. Rather, it simply uses creativity, and prior art, to devise new and better ways of collecting sunlight.

### BRIEF DESCRIPTION OF THE SEVERAL VIEWS OF THE DRAWING

The first four embodiments of the invention pertain to the introductory arrangements, and they are numbered as follows: Embodiment 1, Embodiment 2, Embodiment 3, and Embodiment 4.

The fifth and sixth embodiments envision an entire network of Solar Igloos, and a wireless Solar Igloo, respectively, and are numbered Embodiment 5, and Embodiment 6, respectively.

The seventh through sixteenth embodiments are designed for various other applications, and are numbered, sequentially, Embodiment 7 through Embodiment 16.

The invention is presented this way because each embodiment is important and distinct enough (in its own right) to require mention, and, yet, simply a particular species of the same genus.

With is in mind, then, there are three drawings presented in this application, as follows:

FIG. 1 (which is particularly helpful in understanding Embodiments 1 through 4, and also helpful in understanding the other embodiments);

FIG. 2 (which presents a possible addition to the various embodiments);

FIG. 3 (which is helpful in understanding Embodiment 5, and the other embodiments that would use a network of more than one Solar Igloo).

Each drawing is presented in portrait orientation, with the top of the drawing at the top, the bottom of the drawing at the bottom, the left side of the drawing at the left, and the right side of the drawing at the right.

Further, each drawing should be looked at as though the viewer were standing on level ground, or sitting on a level chair, and looking straight ahead at it, more or less, as you would look at something in front of you in the real world.

### DETAILED DESCRIPTION OF THE INVENTION

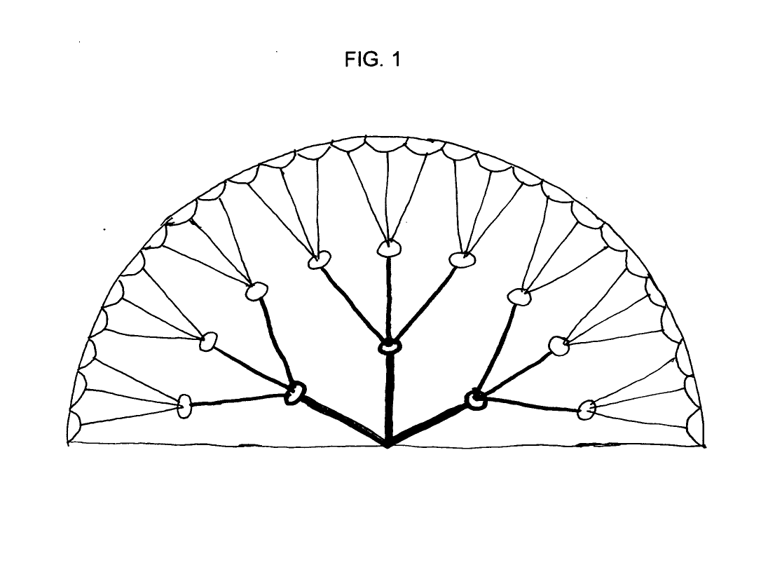

Embodiment 1 of the Solar Igloo is represented in FIG. 1, and is described below.

A person can think of Embodiment 1 as a building in the shape of a perfect semi-circle, which looks rather like an igloo.

(In truth, a Solar Igloo could be in just about any shape. It could be flat, for example, and leaned up against the side of a mountain, or placed parallel to the ground, or affixed to the roof of a building [or, on the roof, or hood, or trunk of a car, for example] with enough room left behind it, in each case, to allow its inner workings to properly take place.)

Although Embodiment 1 would be vastly larger than half a golf ball, nonetheless, it would somewhat resemble half a golf ball, with the flat edge facing the ground.

Where each of the dimples of the half golf ball would be, this igloo would, instead, have a magnifying glass, such that the entire igloo would be full of equally spaced magnifying glasses, each being exactly (or, essentially) the same size and shape (whatever size and shape that happened to be, given the cost, and optical characteristics, etc., determined to be most appropriate to the situation then at hand).

Each magnifying glass could, in fact, be made of glass, because glass has that wonderful “greenhouse” principle of readily letting sunlight in, without letting all the heat get back out. But, if some other material (like some form of clear plastic, for example) proved to be even better, then, that could be used instead.

The magnifying glasses should, to the furthest reasonable extent, be designed to offer the absolute minimum amount of resistance to the sunlight trying to get through them, so a minimum amount of sunlight would be lost in getting through. This may possibly mean the magnifying glasses should be as thin as reasonably possible, so as to barely interfere with the flow of the sunlight. (We just want to bend the sunlight a little, as detailed below, and essentially offer no other interference.)

Each magnifying glass should also be designed in such a way as to maximize the extent to which the light (once it has passed through the magnifying glass in question) has been focused into a workable, concentrated beam.

In between the magnifying glasses, on the exterior layer (or, exterior “constellation”) of magnifying glasses, would be the structural skeleton that holds those magnifying glasses in place. That structural skeleton should be as strong as necessary, and also provide a thermally-tight seal, if desired (and, a water-tight seal, if desired) throughout the structure, like a greenhouse, so only a minimal amount of heat can escape, and so the structure doesn't leak.

(Vents could perhaps be included, too, if desired, so the operator would have the option of releasing some heat, and/or letting in some water.)

In studying FIG. 1, note that the only part of the exterior constellation of magnifying glasses shown are those twenty-seven magnifying glasses that would be directly overhead, at a 90 degree angle (perpendicular) to the ground. In truth, the entire structure would have many more magnifying glasses along its exterior, if you include the ones that would be at an 89 degree angle to the ground, on both sides, and an 88 degree angle to the ground, on both sides, etc., all the way down to a 0 degree angle to the ground, on both sides, but, so the interior features of the Solar Igloo can be seen, as well, all those other exterior magnifying glasses have been intentionally kept off of FIG. 1, and, thus, FIG. 1, in truth, only represents a thin slice of the actual Solar Igloo (the slice that exists at a 90 degree angle to the ground).

If the entirety of The Solar Igloo were to be seen, it would not only resemble half a golf ball (as noted above) but, additionally, could also be likened to the canopy of a mature tree, wherein each magnifying glass is rather like a leaf on such a tree, with each such magnifying glass collecting the sunlight that hits it, for the Solar Igloo, like an actual leaf collects the sunlight that hits it, for an actual tree.

Although the canopy of an actual tree, in nature, may be high in the air (having been raised there by its long tree trunk, in an effort to rise above any obstacles that might block its leaves from the sun, in its natural struggle for survival) the canopy of the Solar Igloo, as pictured in FIG. 1, doesn't have such a trunk (but, nonetheless, possibly could have one, for the same reason that an actual tree has one).

Additionally, because the canopy of the particular Solar Igloo described here would be in the shape of half a golf ball, it would have magnifying glasses that cover the full range of the sun's path across the sky each day (like the canopy of an actual tree does) and could, therefore, remain still (while collecting the sun's light) and not have to move throughout the day, to follow the sun in its path across the sky (like some flowers do, and like the solar energy inventions that mimic such flowers must do).

Below the exterior constellation of twenty-seven magnifying glasses, as depicted in FIG. 1 (which, as previously mentioned, act rather like leaves for the Solar Igloo) there is a “first intermediary constellation” of nine magnifying glasses, in FIG. 1, each of which receives the beam of light forwarded to it by three exterior magnifying glasses, in particular, which are directed to it.

And, below that first intermediary constellation of nine magnifying glasses, as depicted in FIG. 1, there is a “second intermediary constellation” of three magnifying glasses, each of which receives the beam of light forwarded to it by three magnifying glasses, in particular, from the first intermediary constellation, which are directed to it.

As also depicted in FIG. 1, the three magnifying glasses in the second intermediary constellation of magnifying glasses direct their light a single point, at the bottom center of the Solar Igloo. That point is called the “target”.

Thus, all the light collected, throughout the entirety of the Solar Igloo, is collected at (and concentrated in) the “target”.

Insofar as Embodiment 1 of the invention is concerned, then, the solid lines, in FIG. 1, that connect the magnifying glasses in one constellation to magnifying glasses in the next constellation, represent the beams of light traveling from the one constellation to the next constellation.

Thus, when viewing FIG. 1 as a whole, one can see that FIG. 1 (in one way) looks rather like a leaf itself, with the beams of light on it resembling the veins of that leaf, all working in harmony to collect the sunlight at the exterior surface and relay it back to the “target”.

When looking at FIG. 1 in a different way, each one of the magnifying glasses, themselves (in the exterior constellation) resembles a leaf, and all the beams of light connecting one constellation to the next constellation look like branches. Further, those branches would get bigger and bigger, as they approached the “target”, just like the branches on an actual tree would tend to get bigger and bigger, as they lead back to the trunk of the tree.

Then, at the “target” of the Solar Igloo, would be a piece of equipment that would convert all the sunlight collected at the “target” into electricity.

In one approach, the piece of equipment at the “target” might be a steam engine, which a person of reasonable skill in the art could arrange to take all the sunlight collected at the “target”, and use to boil water into steam, and thereby use the steam engine to power a generator, which would generate electricity.

(If desired, the water that was boiled off in such an arrangement could possibly be collected, cooled, and recycled back into the system, such that there wouldn't an endless need for more and more water to be fed into the system, because, to a reasonable degree, no water would ever be lost.)

Alternatively, there could be a solar cell (or, some other form of prior art) instead of a steam engine, which could be placed at the target, to convert all the sunlight into electricity.

As a tool for generating electricity from concentrated sunlight, a well-built Solar Igloo might yield much better results than the mirror-based systems which are popular these days, because mirrors absorb a significant amount of the sun's energy (rather than reflect it along efficiently, as intended) while the Solar Igloo, by contrast, has a magnifying glass system, which (if properly constructed) would absorb much less of the sunlight in question, and be able, therefore, to pass along much more of said sunlight for its intended purposes.

(Mirrors would not have to be absolutely excluded from embodiments of the Solar Igloo, necessarily. Indeed, if/as truly appropriate, and superior, mirrors could be used in combination with, and in harmony with, magnifying glasses, but it's generally expected that magnifying glasses will show themselves to be superior to mirrors.)

Lastly, it would have to be clearly understood that the size, shape, materials, and design, of all the magnifying glasses in question, would have to be very workable and simple, to allow for low-cost mass production.

If these igloos were made properly, and simply, in a cost effective way, whole fields of them (or, whole “forests” of them, to keep with the analogy of a tree) could be put in desert areas (like California's Mojave Desert) and other areas, and possibly generate a great deal of inexpensive, clean electricity.

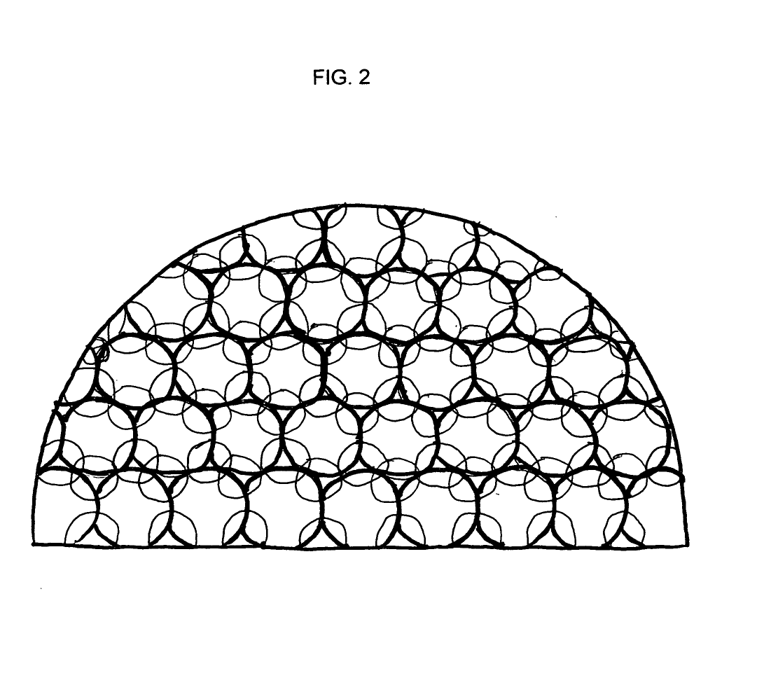

In FIG. 1, there are three constellations of magnifying glasses, there are three magnifying glasses pointing to each magnifying glass in each intermediary constellation, and each magnifying glass is round. FIG. 1, however, is only one example of a Solar Igloo, and that particular arrangement need not always be the one chosen. The numbers and shapes of such things should, rather, be the ones best suited to the situation then at hand.

Where circle-shaped magnifying glasses were used, for example, another exterior constellation of magnifying glasses could be added, to overlap the original exterior constellation, and thus fill the areas where the corners of square-shaped magnifying glasses would have been, if square-shaped magnifying glasses had been used (so sunlight could be collected in these areas, as well) without adversely impacting the original, exterior constellation's ability to collect sunlight. FIG. 2 illustrates how this could be done.

Furthermore, if each constellation of intermediary magnifying glasses dilutes the sunlight somewhat, then, the number of such intermediary constellations could be kept to a reasonable minimum. On the other hand, if each such intermediary constellation amplifies the sunlight appreciably, then, the number of such intermediary constellations could be kept to a reasonable maximum.

In any case, it may not be particularly easy (given the naturally occurring “focal length”, of all the magnifying glasses used) to get the magnifying glasses to focus their sunlight onto one workable “target”, far inside the igloo. Embodiment 2, therefore, addresses that issue.

Embodiment 2 can also be represented by FIG. 1, and is described below.

Embodiment 2 is the same as Embodiment 1, except that on the underside of each magnifying glass (the side that is closer to the “target”) there is focusing apparatus, which could be constructed by a person of reasonable skill in such prior art.

In one approach, the focusing apparatus might be rather like the focusing apparatus on a microfiche reader, which enables the user of such a reader to focus the image he/she is looking at, on the reader's screen.

In another approach, the focusing apparatus might be rather like a telescope, or, one eye's portion (half) of a pair of binoculars, wherein adjustments can be made to one (or more) lenses, in order to focus the image in question, and, if desired, made to include a tube (like the one that connects the lenses on a telescope, or, the lenses on the half of the binoculars in question) which would likewise connect each magnifying glass, in the Solar Igloo, to that particular magnifying glass, in the next constellation, which it is directed to.

Thus, insofar as Embodiment 2 is concerned, the uppermost portion of the straight lines, in FIG. 1, which connect the magnifying glasses in one constellation to magnifying glasses in the next constellation, can be thought of as including one or more of the forms of the focusing apparatus, which are specified above (or, which a person of reasonable skill in such prior arts would deem appropriate) on the underside of each magnifying glass in each constellation.

Further, insofar as Embodiment 2 is concerned, the remainder of the straight lines in FIG. 1, which connect the magnifying glasses in one constellation to magnifying glasses in the next constellation, can be thought of as either representing the above-referenced telescope or binocular-type tubes (in the cases where such tubes are used) or, as simply representing the beams of light passing from one magnifying glass to the next constellation (in the cases where no such tubes are used).

Such a focusing apparatus would be constructed by a person of reasonable skill in such prior arts, for the purpose of better focusing the beams of sunlight that develop, once the sunlight in question has passed through the magnifying glasses in question, so as to enable that light to be more efficiently and effectively transported, from one constellation to the next, and, ultimately, to the “target”.

Embodiment 3 of the invention can also be represented by FIG. 1, and is described below.

Embodiment 3 is the same as Embodiment 2, except that in Embodiment 3, the magnifying glasses in one constellation are connected to the magnifying glasses they're directed to, in the next constellation, by fiber optic cable (that is, not by beams of light alone, or, by telescope or binocular-type tubes with the beams of light inside them, as was specified to be the case for Embodiment 2, as described above).

(It should be noted further, however, that the focusing apparatus, as specified for Embodiment 2, above, could, indeed, be retained for Embodiment 3, if/as desired.)

Thus, insofar as Embodiment 3 is concerned: The uppermost portion of the straight lines, in FIG. 1, which connect the magnifying glasses in one constellation to magnifying glasses in the next constellation, can be thought of as including one or more of the forms, of the focusing apparatus, which are specified for Embodiment 2, but the remainder of each of those straight lines should be thought of as representing a fiber optic cable, which connects a magnifying glass in one constellation to the magnifying glass it's directed to, in the next constellation.

Such a fiber optic cable would be connected to the underside of each magnifying glass (the side of the magnifying glass that is closer to the “target”, at the bottom center of the Solar Igloo) rather like the top of a garden hose (which, itself, is connected to a common kitchen funnel, at the funnel's lower and narrower end) might be connected to the underside center, of a bucket of water (which has an outwardly rounded bottom, and a hole in the center of that bottom—where all the water wants to leak out, and be funneled through the funnel, and then be directed down the attached garden hose).

In the same way that such a funnel, when properly connected to the underside center of said bucket, would collect all the water draining out of the bucket, and funnel it down into the garden hose, for transport through the garden hose, so, too, a similar connection of a fiber optic cable, to the underside center of a magnifying glass, would act to funnel all the sunlight collecting at the underside center of said magnifying glass, into the fiber optic cable in question, for effective and efficient transport to the next constellation, where, with a simple connection (by a person of reasonable skill in the art of fiber optic cable connections) the bottom end of said fiber optic cable would be connected to the top side of the magnifying glass it is directed to (and, reasonably near to the center of that top side) in the next constellation.

Then, this process would be repeated, from constellation to constellation, until all of the sunlight collected, throughout all of the Solar Igloo, would be effectively and efficiently funneled down to the “target”, at the bottom center of the Solar Igloo.

To conceptualize how this would work, think of how a cable television (TV) company, with a fiber optic network, operates. Specifically, they start a movie on their company's digital video disk (DVD) player, essentially. (Let's say it's a “silent” movie, in black and white.) Then, via their fiber optic network, which connects their DVD player (essentially) to the many TVs, of their many customers, they send out those flickering images of black and white light, to their customers' many TVs.

What is being done here, in Embodiment 3, is essentially the same thing—except, in reverse.

In other words, the sun sends out a signal of light (like the light of that “silent”, black and white movie) and then Embodiment 3 of The Solar Igloo, with its own fiber optic network, of sorts, would receive such light signals from the sun, in very little pieces (via the many magnifying glasses at the exterior constellation of the Solar Igloo) and, then, would use its fiber optic network to send that flickering light back to the “target” of the Solar Igloo, where it would be re-unified.

With such an approach, the way in which the fiber optic cable is connected to each magnifying glass would have to be carefully engineered (rather like a good traffic engineer carefully designs the curves on a highway) so the curves are not too sharp, and the fiber optic network doesn't over-heat.

In other words, sunlight is just light (and nothing else) until you stop it, and thereby absorb it. Then, it “becomes” heat, and can over-heat the fiber optic cable. (This is a very important point.)

Therefore, insofar as the Solar Igloo is concerned, we don't want to stop any more of the sunlight (which is simply trying to pass through the fiber optic network, unhindered, like cars on a highway) than necessary. And, foolishly setting up sharp turns in the network would, in fact, stop the sunlight, and “crash” its light particles into the wall(s) of the fiber optic cable (like cars crashing into a wall along the highway) thereby converting the sunlight into “heat”, and absorbing it, and over-heating said fiber optic cable.

Rather, with very gentle bending, and no sharp turns (again, like a good traffic engineer would design the turns on a highway, so they can be safely handled, and so cars don't crash into the guard-rails, or walls, along the side of the road) we just want to gently bend the light through the network, and to the “target”, without creating (and absorbing) any more heat than absolutely necessary.

In another analogy, this situation might be likened to a bad electrical circuit. Electricity doesn't have to get hot, and over-heat the electrical circuit, but a badly engineered electrical circuit might bring that result. Likewise, a Solar Igloo doesn't have to over-heat, but a badly engineered one might do so.

(For possibly even greater control, still, in directing and maintaining the trajectory of the particles of sunlight through the Solar Igloo, the prior art of “rifling” [creating spiraling grooves inside the barrel of a gun] could be ever so diligently incorporated into the design of the fiber strands, of the fiber optic cable in question—if not already done so—by a person of reasonable skill in those arts, so the path of the light through the fiber would maximize the extent to which the light particles would stay on course, and minimize the extent to which they would crash into the sides of the fiber, and thereby be converted into “heat”.)

(The steam engine, or solar panels, or other prior art, at the “target”, can then stop the maximum amount of light itself, and thereby create the most heat, and thereby absorb the most heat itself—which, in fact, is its very purpose.)

It's worth noting that trees, too, are excellent at refraining from converting sunlight into heat, such that people sit under trees, in hot weather, because they're so cool. The leaves, trunk, and branches aren't scorching (like a solar-energy mirror, likewise facing the sun, would be) and the lesson to be learned from this has been used in the Solar Igloo's design.

Nonetheless, in some cases, it may even be that the Solar Igloo's fiber optic cables would have to be cooled, and/or kept in a large bath of cool water, so they don't over-heat. This should come as no surprise, perhaps, given that trees, themselves, must consume enormous amounts of water in order to endure many hours in the face of the very same fireball—the sun.

(In one possible solution, some of the electricity generated by the Solar Igloo could be used to power a refrigerator, of sorts, that could provide a cool bath for the Solar Igloo, or otherwise keep it from over-heating.)

Embodiment 4 of the invention is the same as Embodiment 3, except that there would only be one constellation of magnifying glasses, in Embodiment 4, and that would be the exterior constellation.

In Embodiment 4, each magnifying glass in the exterior constellation would be connected to a fiber optic cable, as described in the description for Embodiment 3, above, but, then, each fiber optic cable would either lead directly to the “target”, or, lead directly to junction(s) with other fiber optic cables, which, themselves, would ultimately lead to the “target” (with no intermediary constellations of magnifying glasses along the way).

Thus, insofar as Embodiment 4 is concerned, FIG. 1 should be viewed as follows: What was previously viewed, for Embodiments 1, 2, and 3, as representing the nine magnifying glasses of the first intermediary constellation, and the three magnifying glasses of the second intermediary constellation, should now be viewed, for Embodiment 4, as representing two very different things, at the same time.

The first thing that each such marking should be viewed as representing, is a junction point of fiber optic cables. (In the case of FIG. 1, such a joining together always involves three fiber optic cables.)

The second thing such a marking should be viewed as representing is a “signal booster” along the fiber optic cable.

(In the same way that a cable television company might use a “signal booster”, of sorts, along one of the fiber optic cables of its own network, to cost-effectively perpetuate the light of a television signal throughout its transit (from its source, at the cable television company, to its ultimate destination, at the consumer's television) so, too, such a “signal booster”, in the Solar Igloo, might be cost-effectively used to boost the signal of sunlight (traveling from one end of the Solar Igloo, to the other) in much the same way, and as a person of reasonable skill in such prior arts could accomplish.

In actual practice, the placement of “signal boosters” wouldn't always have to be limited to the junction points of fiber optic cables, as they are in FIG. 1. (They could, in truth, be placed just about anywhere along a cable.)

The use of “signal boosters” is not a requirement for Embodiment 4, but, rather, just an option.

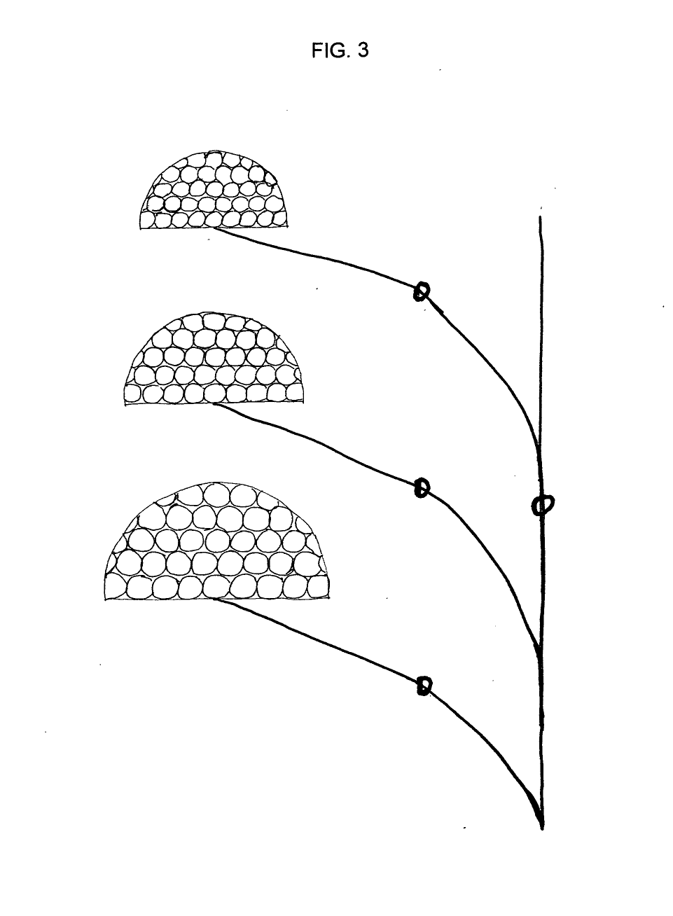

Embodiment 5 is shown in FIG. 3, and is described below. Embodiment 5 is the same as Embodiment 4, except as follows.

Embodiment 5 is an actual network of Solar Igloos (or, in keeping with the earlier likeness of a Solar Igloo to the canopy of a mature tree, one might say Embodiment 5 is actually a “forest” of Solar Igloos) wherein the sunlight collected at the “target” of each Solar Igloo is then transported elsewhere, by a network of fiber optic cable, for whatever reasonable purpose(s) desired.

The inventor refers to the fiber optic cable, which all these Solar Igloos would be connected to, as, “The Sunshine Superhighway”.

There could be “signal boosters” to (and/or along) The Sunshine Superhighway”, if/as desired, to help perpetuate the sunlight across said network (like those explained in the description for Embodiment 4) except that the marks which indicated both junction points and “signal boosters”, for Embodiment 4 (on FIG. 1) represent examples of “signal boosters” only, in FIG. 3.

(There could also be a team of one or more refrigerators, of sorts, stationed along the way, to provide a cool bath for the Sunshine Superhighway, or otherwise keep it from over-heating, similar to the kind that was described earlier, for the Solar Igloo itself, and that cooling system could, possibly, be powered by converting some of the sunlight passing through the Sunshine Superhighway into electricity.)

The Sunshine Superhighway would allow sunlight to be transported widely, much like the electric grid enables electricity to be transported widely. Thus, it could give us a brand new “utility”, of sorts (as further mentioned in the description for Embodiment 15).

In the same way we have a cable television network throughout the country (or, the internet—the so-called “Information Superhighway”—throughout the world) by which light signals generated in one place can be transported to another place, so, too, we could build an infrastructure by which sunlight collected in one place could be transported to another place, for a variety of useful purpose(s) in that other place.

Embodiment 5, itself, would involve cases where the transmission of sunlight might be more effective, efficient, or convenient than the transmission of electricity, in the electricity-generation and electricity-distribution industries. (Specifically, the sunlight could be left as sunlight, and transported as such. Then, only when it had actually arrived at its intended destination, would it be converted into electricity, and distributed, as such, from that point.)

On a local level, a Sunshine Superhighway could be used to route all the sunlight collected in one area, at the “targets” of many Solar Igloos, for example, to a huge local steam engine, or team of steam engines, for the purpose of generating electricity.

On a more regional, or national level, a Sunshine Superhighway could be used to route all the sunlight collected in one area, to a huge steam engine, or team of steam engines, in another state, or another region of the country, given that the transmission of light (as mentioned above) might be more efficient, in some circumstances, than the transmission of the electricity, itself, would be. Then, once the sunlight had arrived at its destination, it could finally be converted into electricity by a steam engine, or other form of prior art.

On a more global level, a Sunshine Superhighway (possibly in conjunction with a worldwide network of wireless transmission satellites, for example—see Embodiment 6, below) could be used to transmit sunlight from the daylight side of the earth to the nighttime side, so that neither side of the earth would ever be without solar power (even when the sun isn't shining in their particular part of the world).

(Thus, just as the sun shines twenty-four hours per day, seven days per week, without ever turning off, so, too, solar power itself would also be available “everywhere and at all times”.)

Embodiment 6 of the invention is described below. Embodiment 6 would be the same as Embodiment 5, except as follows.

Embodiment 6 is a “wireless” version of the Solar Igloo, which could be used alone, or, in concert with “wired” Solar Igloo(s) and/or other “wireless” Solar Igloo(s), and/or as something which is hooked up to a simple network, or, to The Sunshine Superhighway.

By the term, “wireless” Solar Igloo, the inventor means a Solar Igloo that has a wireless transmitter attached to it, at its “target”.

Specifically, one or more such “wireless” Solar Igloos (each, very possibly, in a flat, rather than a semi-circular shape) could be set up on earth, or brought up into space, and (when brought up into space) positioned rather like a communications satellite (except that each such Solar Igloo would be strategically pointed toward the sun, to optimize the amount of sunlight it could collect) and the sunlight it would collect would simply be “light” (as further explained, below) and should not be thought of as being anything else).

The wireless transmitter attached to each such Solar Igloo, at its “target”, could then transmit said light wirelessly (and, most likely, back to a desired location on the earth) like the technology used for wireless satellite communications can transmit the light of a television signal from such a satellite back to a receiver on the earth.

The important thing to remember here, once again, is that sunlight is only “light”, and nothing else, until you stop it—at which point you absorb it, and it “becomes” heat. The objective here, as stated earlier (for other embodiments of the Solar Igloo) is to do nothing more than gently bend the sunlight a little (like a good highway engineer would simply bend highway traffic a little, in a gentle way) so as to simply collect the sunlight, without causing a “crash” of the light particles (which would create heat, and over-heat the wireless [and/or wired] transmitters and receivers, among other things).

The wired or wireless receivers that would receive these signals could be on buildings and/or towers on the earth, and/or on other satellites (some of which, themselves, might possibly serve as “signal boosters”, if/as desired) all according to how a person of reasonable skill in the prior art of wireless satellite communications would do.

Further, the wired or wireless transmitters (whether in space, and/or on earth) could be arranged in a constellation, at whatever altitude(s) desired, to collect sunlight in a certain part of the sky, and transmit it back to earth, and/or work as a network (and/or, a relay team, which transmits light from one, or more, satellites to the next, in a chain that extends from the earth, to further and further toward the sun).

Once the light is received back on the earth, it could be collected and fed into steam engine[s] (or other forms of prior art, like solar panels, for example) to generate electricity, as previously explained.

(For possibly even greater control, in directing and maintaining the trajectory of the particles of sunlight through the wired and wireless transmitters, and receivers, the prior art of “rifling” [creating spiraling grooves inside the barrel of a gun] could be ever so diligently incorporated into the design of the transmitters and receivers, as well, by a person of reasonable skill in those arts, so the path of the light through those devices would maximize the extent to which the light particles would stay on course, and minimize the extent to which they would crash into the sides of those devices, and thereby be converted into “heat”.)

(Additionally, some power source—which could be some of the sunlight passing through, or near, the wired or wireless transmitters and/or receivers, that is convertible into electricity—could be used to power a refrigerator, of sorts, that could provide a cool bath for the transmitters and/or receivers, or otherwise keep them from over-heating.)

Embodiment 7 is described below. Embodiment 7 is the same as Embodiment 6, except as follows, and pertains to Air Force (military) applications of The Solar Igloo.

For the purposes of this description, the term “regular lasers” is hereby defined as any lasers that use some kind of light, other than sunlight, to generate the laser beams they cast, and, the term “sunshine lasers” is hereby defined as any lasers which would use sunlight itself—either in its natural state, or, in some altered state—to generate the laser beams it casts.

(As a side note, the term “unwired” Solar Igloo is also hereby defined as a Solar Igloo that is neither wireless, nor wired, and not connected to any other Solar Igloos, or other equipment.)

Embodiment 7 envisions a single “sunshine laser”, or, a network of “sunshine lasers”, with each positioned at the “target” of a Solar Igloo (be it a wireless, wired, or unwired Solar Igloo, and, be it in space, on the earth, in the sea, or elsewhere).

Further, a “sunshine laser” would simply be a “regular laser” that is (most likely) positioned at the “target” of a Solar Igloo, and has been modified in the ways a person of reasonable skill in such prior arts could accomplish, so that the light beams it casts would be derived from the sunlight it collects at the “target” of the Solar Igloo(s) in question.

For possibly even greater control, in directing and maintaining the trajectory of the particles of sunlight through the “sunshine lasers”, the prior art of “rifling” [creating spiraling grooves inside the barrel of a gun] could be ever so diligently incorporated into the design of the “sunshine lasers”, as well, by a person of reasonable skill in those arts, so the path of the light through the “sunshine lasers” would maximize the extent to which the light particles would stay on course, and minimize the extent to which they would crash into the sides of the “sunshine lasers”, and thereby be converted into “heat”.

(Additionally, some power source—which could be some of the sunlight passing through, or near, the “sunshine lasers”, themselves, and convertible into electricity—could be used to power a refrigerator, of sorts, that could provide a cool bath for the “sunshine lasers”, or otherwise keep them from over-heating.)

(In many cases, Embodiment 7 would possibly be a network of essentially flat, wireless Solar Igloo[s], in space, with one “sunshine laser” at the “target” of each Solar Igloo in question, and with all those “sunshine lasers” working in concert with one another, in a network over the continental United States.)

Using a network of such “sunshine lasers”, each equipped with a laser guidance system, as well, an array of “sunshine laser beams” could be focused onto one (or more) incoming nuclear warheads, and used to either melt, explode (possibly using pulsations of such laser beams, along with the heat of them, as they're absorbed on the warhead) or otherwise disable said nuclear warhead[s] (rather like President Ronald Reagan's idea of a Strategic Defense Initiative (SDI), or, “Star Wars”—except, this would use sunlight as the source for the laser beams).

And, because sunlight is just light, and moves at the speed of light (which is, essentially, the fastest speed known in the universe) such a “sunshine laser beam” (or, such an array of “sunshine laser beams”) should be fast enough to hunt down any nuclear missiles fired at the United States (or anyone else).

This being the case, it would seem that acquiring (and being able to defend) the highest position in the sky (the closest position to the sun, that is, because the sun is the source of all this light, for all these “sunshine laser beams”) would then become a key objective in military strategy, much like acquiring (and being able to defend) the highest piece of land, in an old-time military battle, was long understood to be of great importance in such a military campaign (with the general view being that he who controls the highest position on the battlefield is very much favored to win the battle).

Embodiment 7 would be equally well-suited to shooting down other things, too, like enemy aircraft, with the same kind of “sunshine laser beam”, or, network of “sunshine laser beams”.

Another Air Force (military) use for Embodiment 7 would be as follows: Rather than send thousands of marines to their deaths, in an invasion of some place like Iwo Jima, during World War II, Embodiment 7 could possibly be used (perhaps via a network of Solar Igloos, some of which might be in space) to beam down extraordinary amounts of sunlight onto an opponent's fields, and/or industry, and/or the opponent himself, so life there (and further resistance) becomes impossible, but, without necessarily causing any environmental or other damage, except to the extent truly necessary (in which case, such light-beaming could cause a drought, or a famine—but, if great caution wasn't observed, might cause a “fire and brimstone” type firestorm).

In another Air Force (military) use, Embodiment 7 could bring daylight (from the other side of the world) to light up the night, or, could be used to locate (and, then, power one or more night-vision sensors, or cameras, or a network thereof [and/or daylight sensors or cameras] from the electricity it could generate from sunlight, as mentioned in the description for earlier embodiments of the Solar Igloo).

Embodiment 8 is the same as Embodiment 7, except as follows.

Embodiment 8 would be focused on Army (or, earth-based military) applications than the sky-based ones of Embodiment 7, and, with its own “sunshine laser”, or, network of “sunshine lasers”, could be used as a heat-thrower, or, essentially, a flame-thrower, of sorts, for either the heating (to induce surrender) and/or the out-right melting, or, the setting-on-fire (if truly necessary) of enemy targets on the ground, including (but not necessarily limited to) enemy tanks, fortresses, and explosives.

Embodiment 9 would be the same as Embodiment 8, except that it would be focused on the Navy applications of the invention, and thus comprise the “at sea” version of Embodiment 8—for above-water operations (and/or, for below-water operations, to the extent possible).

Embodiment 10 would be the same as Embodiment 9, except that it would be focused on the law enforcement applications of the invention, such as (but not necessarily limited to) the following: heating criminals out of their cars, from a distance; heating hijackers out of an airplane, from a distance, without hurting the hostages; destroying an illegal-drug-grower's crops from the air, by heating them from the air, so they all wilt, and die, but without destroying the soil, or causing any other environmental, or other damage (similar to a crop failure in the 1930s); or, for possible use in powering a night-vision system (as set out in the description for Embodiment 7).

Embodiment 11 would be the same as Embodiment 10, except that it would be focused on the industrial applications of the invention, such as a heavy-duty blow-torch, or a welding torch.

Embodiment 12 would be the same as Embodiment 11, except that it would be focused on the agricultural applications of the invention, such as the following:

In the same way that water can be drawn into a desert, or an under-watered area, to re-claim the land from the desert, and use it for productive agricultural use, so, too, Solar Igloos could be used to help re-claim land from the desert by taking away the excess sunlight that's present there.

Flat Solar Igloos, for example (which are just like regular Solar Igloos, except for the fact that their shape is flat) could be placed parallel to the ground, at whatever height from the ground is desired (say twenty feet, for example) and be supported there by pillars at the corners and/or elsewhere along the edges.

When sunlight on the crops is wanted, the magnifying glasses, individually, or, the whole structure, itself, could be opened, like a door (or, Venetian blinds) lying parallel to the ground might be opened, so the sunlight could enter.

Then, when enough of the day's sunlight had been taken in by the crops, the magnifying glasses, individually, or, the whole structure, itself, could be closed, like a door (or, Venetian blinds) lying parallel to the ground might be closed, so the crops are then shielded from any further sunlight. Then, whatever sunlight is collected by the flat Solar Igloo(s) could be taken away, either for transport to some other region of the country, etc., where it might be needed, or, to a team of local steam engines, for example, for conversion to electricity.

As a more elaborate version of this idea, a team of these flat Solar Igloos, strategically placed in the sky like a bunch of communication satellites, could, perhaps, accomplish the same thing, over the entire area of a desert, or similar land area.

Embodiment 13 would be the same as Embodiment 12, except that it would be focused on lighting, as follows:

After flat Solar Igloo(s), like the ones mentioned in the description for Embodiment 12, had transported the excess sunlight in one location to a second location (where, perhaps, sunlight was in short supply) there could also be “Reverse Solar Igloo(s)” at that second location, which could take the sunlight thus received, and convert it back into light, somewhat like a telephone receiver takes the signal of a human voice, that is sent to it over a telephone wire, and then converts it back into something that resembles an actual human voice.

Embodiment 14 would be the same as Embodiment 13, except that it would be focused on climate control applications, as follows:

The transport of excessive sunlight from a first location, and, then, to a second location (which had a shortage of adequate sunlight) could be used to serve two worthwhile, climate-control objectives (one in each location) by removing excessive heat from the first location, and adding needed heat to the second location.

Embodiment 15 would be the same as Embodiment 14, except that it would be focused on utility applications, as follows:

The transmission of sunlight could be made as ubiquitous as the transmission of electricity (as mentioned previously, in the description for Embodiment 5) and thereby be made into another “utility”, like the electric company.

However, where Embodiment 5 addresses the possible use of transmitting sunlight from one place to another, for the purpose of enabling industry to generate electricity (from that sunlight) in that second location, Embodiment 15 would involve providing a constant and measured amount of sunlight to consumers themselves—not for the purpose of converting it into electricity, but, rather, for the purpose of using it as sunlight, itself, to power solar-powered appliances.

In other words, Embodiment 15 would be designed to provide a network of continuous and measured transmitted-sunlight to consumers, like the electric grid provides a continuous and measured network of electricity to consumers.

Embodiment 15 would include a “plug in” feature, whereby consumers could plug a solar-powered appliance into a socket, to power it, like consumers currently can plug an electrical appliance into a socket, to power it.

If Embodiment 15 ever became a reality, then, Embodiment 16 could come into being, as follows:

Embodiment 16 would consist of a solar-powered version of many (or, perhaps, all) of the appliances, and other tools, that people like Thomas Edison invented to run on electric power.

For example: Just as a solar powered calculator can be run by sunlight (because sunlight hits a solar panel on the calculator, and is thus converted into electricity) so, too, just about any appliance could have a similar solar panel on it, and be powered by “plugging in” that appliance to a source of transported sunlight.

(Furthermore, in some cases, a solar panel, or some such device, might not even be necessary. For five brief examples, consider that a person of reasonable skill in the prior arts could make a version of a stove, an oven, a dryer, a hot water heater, and/or a furnace, which could simply run on the heat of transmitted sunlight, and not necessarily need any electricity at all.)

The inventor doesn't necessarily think Embodiments 15 and/or 16 need to be made, or should be made, but, nonetheless, mentions them in the interests of thoroughness.

(The remainder of this page is intentionally left blank, and the CLAIMS are begun on the next page.)

1. The inventor, John Edward Fay, makes the independent claim that the invention, called, The Solar Igloo, includes at least:
one (or more) specially crafted lenses, with each one specifically designed to bend the sunlight it encounters into an especially well focused beam (and, to do so in a way that keeps said sunlight especially free from dissipation and dissemination) by the time said sunlight exits the lens(es) in question;
and, at least one intermediary point thereafter, where an especially good focus of each beam is again imposed, and/or maintained (and, again, in a way that keeps each beam especially free from dissipation and dissemination);
and, at least one means of transporting each beam, that keeps it especially well focused (and, yet again, especially free from dissipation and dissemination) up to, and including, the time it reaches its final destination point;
and, a frame, which holds the various pieces of the invention in place;
such that an unusually large portion of the sunlight, which hits the canopy of a Solar Igloo, can be collected and delivered to a single destination point, and used for worthwhile purposes;
all occurring when the invention is properly constructed, installed, monitored, and maintained.

2. The inventor also specifically claims that Embodiment 1 of the invention is a particular species of the genus set out, generically, in claim 1, that it includes all the limitations of claim 1 (and, indeed, imposes even further limitations than claim 1) and, that it, too, can be used for useful purposes.

3. The inventor also specifically claims that Embodiment 2 of the invention is a particular species of the genus set out, generically, in claim 1, that it includes all the limitations of claim 1 (and, indeed, imposes even further limitations than claim 1) and, that it, too, can be used for useful purposes.

4. The inventor also specifically claims that Embodiment 3 of the invention is a particular species of the genus set out, generically, in claim 1, that it includes all the limitations of claim 1 (and, indeed, imposes even further limitations than claim 1) and, that it, too, can be used for useful purposes.

5. The inventor also specifically claims that Embodiment 4 of the invention is a particular species of the genus set out, generically, in claim 1, that it includes all the limitations of claim 1 (and, indeed, imposes even further limitations than claim 1) and, that it, too, can be used for useful purposes.

6. The inventor also specifically claims that Embodiment 5 of the invention is a particular species of the genus set out, generically, in claim 1, that it includes all the limitations of claim 1 (and, indeed, imposes even further limitations than claim 1) and, that it, too, can be used for useful purposes.

7. The inventor also specifically claims that Embodiment 6 of the invention is a particular species of the genus set out, generically, in claim 1, that it includes all the limitations of claim 1 (and, indeed, imposes even further limitations than claim 1) and, that it, too, can be used for useful purposes.

8. The inventor also specifically claims that Embodiment 7 of the invention is a particular species of the genus set out, generically, in claim 1, that it includes all the limitations of claim 1 (and, indeed, imposes even further limitations than claim 1) and, that it, too, can be used for useful purposes.

9. The inventor also specifically claims that Embodiment 8 of the invention is a particular species of the genus set out, generically, in claim 1, that it includes all the limitations of claim 1 (and, indeed, imposes even further limitations than claim 1) and, that it, too, can be used for useful purposes.

10. The inventor also specifically claims that Embodiment 9 of the invention is a particular species of the genus set out, generically, in claim 1, that it includes all the limitations of claim 1 (and, indeed, imposes even further limitations than claim 1) and, that it, too, can be used for useful purposes.

11. The inventor also specifically claims that Embodiment 10 of the invention is a particular species of the genus set out, generically, in claim 1, that it includes all the limitations of claim 1 (and, indeed, imposes even further limitations than claim 1) and, that it, too, can be used for useful purposes.

12. The inventor also specifically claims that Embodiment 11 of the invention is a particular species of the genus set out, generically, in claim 1, that it includes all the limitations of claim 1 (and, indeed, imposes even further limitations than claim 1) and, that it, too, can be used for useful purposes.

13. The inventor also specifically claims that Embodiment 12 of the invention is a particular species of the genus set out, generically, in claim 1, that it includes all the limitations of claim 1 (and, indeed, imposes even further limitations than claim 1) and, that it, too, can be used for useful purposes.

14. The inventor also specifically claims that Embodiment 13 of the invention is a particular species of the genus set out, generically, in claim 1, that it includes all the limitations of claim 1 (and, indeed, imposes even further limitations than claim 1) and, that it, too, can be used for useful purposes.

15. The inventor also specifically claims that Embodiment 14 of the invention is a particular species of the genus set out, generically, in claim 1, that it includes all the limitations of claim 1 (and, indeed, imposes even further limitations than claim 1) and, that it, too, can be used for useful purposes.

16. The inventor also specifically claims that Embodiment 15 of the invention is a particular species of the genus set out, generically, in claim 1, that it includes all the limitations of claim 1 (and, indeed, imposes even further limitations than claim 1) and, that it, too, can be used for useful purposes.

17. The inventor also specifically claims that Embodiment 16 of the invention is a particular species of the genus set out, generically, in claim 1, that it includes all the limitations of claim 1 (and, indeed, imposes even further limitations than claim 1) and, that it, too, can be used for useful purposes.
